(19) United States
(12) Patent Application Publication
(10) Pub. No.: US 2026/0110891 A1
(43) Pub. Date: Apr. 23, 2026

(54) ILLUMINATION DEVICE FOR A MICROSCOPE, IN PARTICULAR FOR A LIGHT SHEET MICROSCOPE, AND METHOD FOR GENERATING A SHAPED ILLUMINATION

(71) Applicant: CARL ZEISS MICROSCOPY GMBH, Jena (DE)

(72) Inventors: Richard Hollinger, Jena (DE); Joerg Siebenmorgen, Jena (DE); Ralf Netz, Jena (DE)

(21) Appl. No.: 19/364,507

(22) Filed: Oct. 21, 2025

(30) Foreign Application Priority Data
Oct. 22, 2024 (DE) 102024210188.5

(51) Int. Cl. G02B 21/08

(52) U.S. Cl. CPC G02B 21/082

(57) ABSTRACT

An illumination device includes an illumination beam path having a cylindrical lens and four optical elements for shaping an illumination radiation in each case in a direction orthogonal to the optical axis, and first and second optical lenses, each having a fixed focal length. The cylindrical lens has an optically refractive effect in exactly one direction, which shapes the illumination radiation in a direction transversely to the active direction. Each of the optical elements, in exactly one direction, has an optically refractive effect or influences a wavefront of the illumination radiation that shapes the illumination radiation in a direction transversely to the active direction. The four optical elements are disposed downstream of the cylindrical lens, and the active directions of the cylindrical lens and of the successive optical elements are directed orthogonally to one another. The illumination radiation downstream of the fourth optical element is directed onto the second optical lens by the first optical lens and the second optical lens directs the illumination radiation into a common focus. A usable length and a width of a light sheet generated with the aid of an illumination objective can be set independently of one another.

### CROSS REFERENCE TO RELATED APPLICATION

This application claims priority to German Application No. 10 2024 210 188.5, filed Oct. 22, 2024, the disclosure of which is incorporated herein by reference in its entirety.

### TECHNICAL FIELD

The invention relates to an illumination device for a microscope, in particular for a light sheet microscope, and to a method for mutually independently shaping an illumination radiation in two spatial directions, in particular for generating a light sheet.

### BACKGROUND

In light sheet microscopy applied to biological samples, in particular, an illumination radiation, usually laser radiation, is shaped into a thin sheet of light (light sheet) and is directed into a sample space, in which a sample to be imaged can be arranged. If the sample is prepared with fluorescent markers which, by means of the illumination radiation, are excitable to emit fluorescent radiation that is usable as detection radiation, or if the sample has autofluorescence, the sample can be imaged very gently by virtue of the light sheet being moved in a targeted manner through the relevant regions of the sample and fluorescence being excited only there. The sample can be scanned using the light sheet by production of a suitable relative movement between light sheet and sample.

A light sheet microscope setup that may be referred to as traditional is described in DE 10 2012 019 466 A1, for example. By means of an illumination beam path and an illumination objective, a light sheet is generated and directed into the sample space. Perpendicularly to the longitudinal extent and width of the light sheet, a detection objective is directed into the sample space in order to capture the excited fluorescence and feed it to a detector via a detection beam path.

### SUMMARY

Zoom optical units are often installed in the detection beam paths, by means of which zoom optical units the captured field of view (FOV) is set and regions of interest and structures of the sample to be imaged are represented in a magnified manner. In order once again to adapt the actually illuminated area to the size of a currently captured field of view, the illumination beam paths can also have a zoom optical unit. In principle, zoom optical units have at least two spherical optical lenses which, according to the desired magnification, are individually displaced or both displaced relative to one another.

In order to shape the illumination radiation for the generation of a light sheet, a so-called cylindrical lens is often used (for details: see further below). By means of this lens, the cross section of the illumination radiation is brought to an approximately rectangular shape. In the process, a beam is subjected to greater influencing in one direction transversely to a direction of propagation than in another direction transversely to the direction of propagation. The length and width of the shape thus generated can be varied by means of the zoom optical unit as required, although length and width of the cross section cannot be set independently of one another. As a result, a usable length and the width of light sheets respectively generated cannot be set independently of one another either.

The fundamental functional procedure for light sheet generation by means of a cylindrical lens and for cross-sectional variation by means of a zoom optical unit is explained below with reference to FIGS. 1 to 5.

FIG. 1 shows, in perspective view and schematically, a cylindrical lens 1, embodied here in planoconvex fashion in the form of a semicylinder. The end face of the cylindrical lens 1 that is enclosed by a solid line faces the observer; the end face enclosed by a partly dotted boundary faces away from the observer. The cross section of the cylindrical lens 1 varies in the direction of an x-axis (x-direction). Depending on the location in the x-direction at which light beams 2 of an illumination radiation or of a detection radiation are incident on the cylindrical lens 1, these beams are influenced differently, in particular deflected to different extents, by the effect of the cylindrical lens 1 (see also FIG. 2). The extent of the cylindrical lens 1 in this direction is also referred to hereinafter as active direction aR. By contrast, the shape of the cylindrical lens 1 does not change in a direction (passive direction pR) which is orthogonal to the active direction aR and which points in the direction of the y-axis (y-direction) shown. In the passive direction pR, incident light beams 2 are not influenced depending on their incidence point.

The effects of the cylindrical lens 1 in its active direction aR and in the passive direction pR are illustrated in FIGS. 2 and 3, respectively. By way of example, if light beams 2 parallel to the optical axis oA reach the convex lateral surface of the cylindrical lens 1, these beams are deflected to different extents depending on their respective incidence point in the active direction aR (FIG. 2). In the case of a planoconvex cross section, the light beams 2, after passing through the cylindrical lens 1, are directed into a linear focus F formed in the direction of the y-axis, and thus perpendicularly to the active direction aR. An optical effect of the cylindrical lens 1 along its active direction aR thus occurs perpendicularly thereto.

FIG. 3 shows the cylindrical lens 1 in a plan view (y-z-plane). The light beams 2 incident in a parallel manner remain parallel to one another in the y-z-plane even after passing through the cylindrical lens 1. No optical effects in the sense of a location-dependent change in direction occur perpendicularly to the passive direction pR.

The relative poses of the cylindrical lens 1, and thus of the active direction aR and of the passive direction pR, can be oriented differently relative to the axes of the Cartesian coordinate system assumed here by way of example. It is also possible for the cylindrical lens 1 to have at least one concave lateral surface. It is also possible that alternation between a convex shape and a concave shape can be implemented. The latter is possible in particular in conjunction with a use of controlledly settable lenses, for example liquid lenses.

FIGS. 4 and 5 illustrate the relationships of the cross section of a light beam in an entrance pupil EP of an objective 3, in particular of an illumination objective 3. FIG. 4 illustrates by way of example a focus F which is shaped by means of a cylindrical lens 1 and which is set with regard to its dimensions by means of a zoom optical unit, which focus is directed into an entrance pupil (plan view) of an illumination objective 3 (left-hand partial illustration). Since the light beams 2 incident radially, in particular in the x-direction, further outwards into the entrance pupil EP (also: objective pupil) are steered in the direction of the optical axis oA to a greater extent than light beams 2 incident nearer to the optical axis oA, a beam having a short beam waist is generated in the sample space. The usable length of a beam waist in the z-direction is indicated here by the Rayleigh length RL, for example. The (average) extent of the beam waist in the x-direction constitutes the thickness D of the usable length of the beam waist, and hence the thickness D of the light sheet thus generated.

At the same time, the light beams 2 that are directed into the entrance pupil EP radially further away from the optical axis oA in the y-direction are steered in toward the optical axis oA in the further course to a greater extent than centrally incident light beams 2. Consequently, the width B of the beam in the sample space as measured in the y-direction is quite small over its usable length in the z-direction.

FIG. 5 shows a situation in which the shaped light beams 2, for example as a result of the effect of the zoom optical unit, are directed into a focus F which is smaller both in the x-direction and in the y-direction in comparison with FIG. 4. As a result, a beam waist is obtained whose usable length (Rayleigh length RL) is longer and whose width B is greater than in the example in FIG. 4. Therefore, a wider light sheet having a greater usable length is obtained, but the thickness D is likewise greater than in the previous example, which adversely affects the resolving power of light sheet microscopy in a detection direction, for example in the direction of the optical axis of a detection objective (z-direction; corresponding to the x-direction of the illumination beam path).

What is disadvantageous is that the usable length RL and the width B can be set independently of one another only with high technical outlay and complexity using mechanical means. In this regard, for example, it is not possible to perform an independent setting using two electrically adjustable optical elements such as liquid lenses or liquid crystal lenses.

The invention addresses the problem of proposing an illumination device which enables an independent setting of a shaped illumination radiation in two directions, for example of usable length and width of a generated light sheet, which setting is simplified in comparison with the prior art. Moreover, the intention is to propose a method for setting an illumination radiation, in particular for generating a light sheet, the usable length and width of which can be set independently of one another.

The problem is solved by the subjects of the independent claims. The dependent claims relate to advantageous developments.

An illumination device according to the invention has an illumination beam path. The latter comprises a first, second, third and fourth optical element for shaping an illumination radiation in each case in a direction orthogonal to the optical axis.

Either each of the optical elements has an optically refractive effect in exactly one active direction or a wavefront of the illumination radiation is influenced in exactly one active direction. In both alternatives, as a result the illumination radiation is shaped in a direction transversely to the active direction.

The four optical elements are arranged successively along the optical axis, wherein the active directions of the directly successive optical elements are each directed orthogonally to one another.

An illumination radiation guided along the beam path, downstream of the fourth optical element, is directed into a common focus by means of at least one relay optical unit having at least one optical lens in each case.

The heart of the invention is the provision of a possible way of being able to set the shape of an illumination radiation in at least two spatial directions independently of one another. An advantageous application consists in the decoupling of the setting of usable length and width of a generated or generable light sheet. What is likewise possible is a setting of the shape of an illumination proceeding from round, oval or other available cross sections of an illumination radiation provided by a light source, for example. As will additionally be explained further below, the optical elements make it possible to vary the numerical aperture in the entrance pupil of the illumination objective. At the same time, all the light beams of the illumination radiation are directed into a stationary common focus, such that as a result the focused light beams allow a precise setting of a width of a light sheet, for example.

In an embodiment of the illumination device which is advantageous because it can be realized in a simple manner, the relay optical unit is formed by at least a first optical lens and a second optical lens each having a fixed focal length. This embodiment of the relay optical unit makes it possible to influence both a phase distribution and an amplitude distribution of the illumination radiation upon passing through the relevant relay optical unit. In further embodiments of the illumination device according to the invention, a further relay optical unit can be present, which in turn has at least one optical lens, but advantageously likewise two optical lenses.

By means of the illumination device according to the invention, an incoming illumination radiation can be shaped in two directions orthogonally to the optical axis and independently of one another. In this case, the incoming illumination radiation can have different beam cross sections, for example round or oval.

For the specific case of the shaping of a light sheet, a cylindrical lens can be disposed upstream of the first to fourth optical elements, wherein the cylindrical lens has an optically refractive effect in exactly one direction (active direction) and as a result the illumination radiation is shaped in a direction transversely to the active direction and the active directions of the cylindrical lens and of the successive optical elements are each directed orthogonally to one another.

Hereinafter the description will discuss by way of example the setting of an illumination radiation and by way of example in particular the generation of a light sheet.

In one embodiment of the illumination device (hereinafter also for short: device) according to the invention, at least one of the first to fourth optical elements is exchangeable, wherein individual configurations of the optical elements are coordinated with one another in order to generate a focus which has desired dimensions laterally with respect to the optical axis. In cooperation with an illumination objective, a light sheet having a predetermined thickness and waist length is generated. This embodiment can be used if overall only a limited number of possible manifestations of the light sheet are intended to be generated and the illumination beam path is readily accessible.

In order not to have to accept restrictions of the possible manifestations of the light sheet in this respect, in a further embodiment of the device according to the invention, the first to fourth optical elements are advantageously each embodied in the form of a controlledly settable optical element. The first to fourth optical elements can each be embodied for example in the form of a liquid lens. These lenses are well known from the prior art and available in diverse embodiments.

It is also possible for the first to fourth optical elements each to be embodied in the form of a spatial light modulator (SLM). In this case, the SLM represents the phase of a Fresnel cylindrical lens. Depending on the design of the illumination beam path, such a light modulator can operate in reflection or in transmission and alter the formation of the wavefront of the illumination radiation in a targeted manner. The abovementioned variants of the optical elements can also be combined.

By means of a controlled setting of at least one of the first to fourth optical elements, the focus can be shifted (axially) in the direction of the optical axis, as required. Like other functions of the device according to the invention, the axial setting of the focus can also be effected by execution of control commands of a controller.

As already discussed above, the illumination device according to the invention can serve for generating a light sheet. For this purpose, the illumination beam path is equipped with an illumination objective. The focus of the relay optical unit is directed into an entrance pupil of the illumination objective in order to generate a light sheet in a sample space by the effect of the illumination objective.

The illumination device according to the invention can be a constituent part of a microscope, in particular of a light sheet microscope.

The problem addressed by the invention is solved, in addition to being solved by the illumination device, by a method for setting the shape of an illumination radiation in two directions independently of one another, in which method an illumination radiation is shaped by means of a number of optically effective components in each case in exactly one direction orthogonal to the optical axis. The term shaping of the illumination radiation is understood to mean both effects owing to refraction and effects owing to a phase shift or an influencing of the wavefront. An illumination radiation guided along the illumination beam path is shaped successively by the effect of different optical components. What is of importance for the invention is that the shaping of the illumination radiation takes place successively and alternately either in a first direction or in a second direction. Both the first direction and the second direction run orthogonally both to the optical axis and to one another and to the respective active direction of the relevant component.

When the method according to the invention is carried out, the illumination radiation is shaped successively in the first direction and the second direction. The incoming illumination radiation is shaped in the corresponding directions by means of a first to fourth optical element. Optionally, a further optical component is disposed upstream of the first optical element, and the illumination radiation is shaped in the first direction, for example, by the effect of said further optical component. Downstream of the fourth optical element, the illumination radiation is directed into a focus, which can be situated in a pupil plane or spatial plane, by means of at least one relay optical unit. The relay optical unit advantageously has a first and a second optical lens having a fixed focal length.

These two optical lenses can be customary spherical lenses that do not influence the illumination radiation in a preferred direction. The illumination radiation is directed into a focus by the effect of the second optical lens. Said focus has no axial shifts of the intersection points of the light beams of the illumination radiation (common focus).

In one configuration, the method according to the invention can advantageously be used to set the focus with regard to desired dimensions laterally with respect to the optical axis of the illumination beam path. As already explained above in regard to FIGS. 4 and 5, a focus having an extent in the x-direction and an extent in the y-direction, for example, is generated in an x-y-plane in which an entrance pupil of an illumination objective can be arranged. These extents are also referred to here as dimensions laterally with respect to the optical axis. The method according to the invention advantageously allows two lateral dimensions directed orthogonally to one another to be set independently of one another.

The method can be used for generating a light sheet. When the configuration of the method according to the invention is carried out, the illumination radiation is shaped in the first direction by means of an optical component, in particular a cylindrical lens, before the beam shaping or influencing steps indicated above are successively executed by the four optical elements.

If the focus is directed into an entrance pupil of an illumination objective, a light sheet having a predetermined thickness and waist length can advantageously be generated in a sample space.

### BRIEF DESCRIPTION OF THE DRAWINGS

The invention is explained in greater detail below on the basis of exemplary embodiments and with reference to drawings, in which:

FIG. 1 shows a schematic illustration of a cylindrical lens and the effect axes thereof in a perspective view;

FIG. 2 shows a schematic illustration of the cylindrical lens and the optical effect thereof in a view in the x-z-plane;

FIG. 3 shows a schematic illustration of the cylindrical lens and the optical effect thereof in a view in the y-z-plane;

FIG. 4 shows a schematic illustration of a first manifestation of a focus in an entrance pupil and of a focused beam resulting therefrom;

FIG. 5 shows a schematic illustration of a second manifestation of a focus in an entrance pupil and of a focused beam resulting therefrom;

FIG. 6 shows a schematic illustration of a first exemplary embodiment of an illumination device according to the invention with an illumination objective;

FIG. 7 shows a schematic illustration of a second exemplary embodiment of an illumination device according to the invention with an illumination objective and combined optical elements;

FIG. 8 shows a schematic illustration of the beam paths of one exemplary embodiment of an illumination device according to the invention in an x-z-plane with an extracted partial figure illustrated in an enlarged manner; and

FIG. 9 shows a schematic illustration of the beam paths of the exemplary embodiment of the illumination device according to the invention in a y-z-plane with an extracted partial figure illustrated in an enlarged manner.

### DETAILED DESCRIPTION

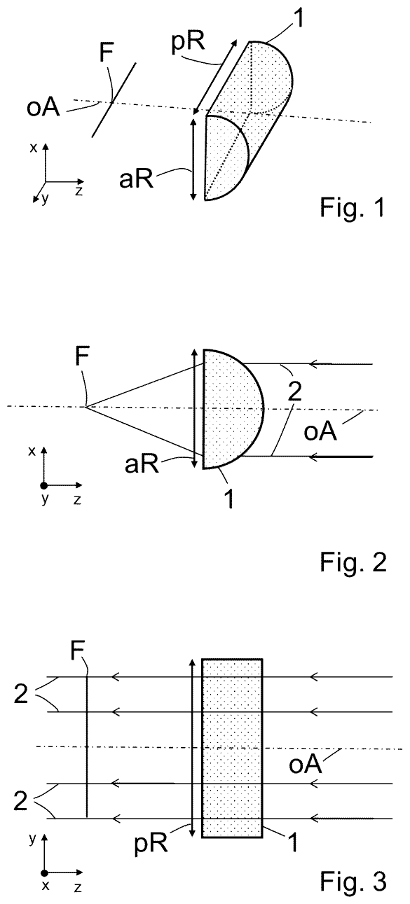

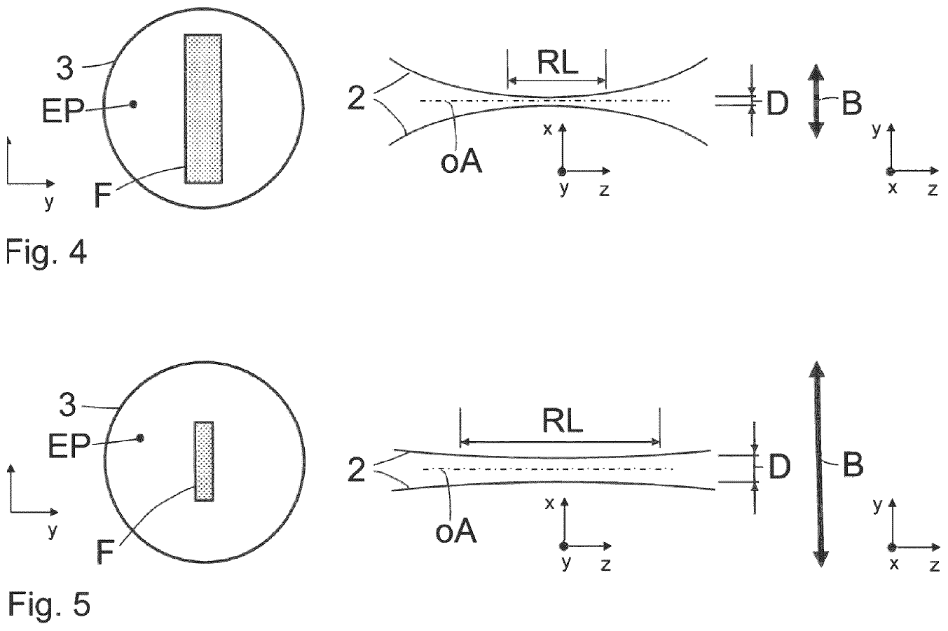

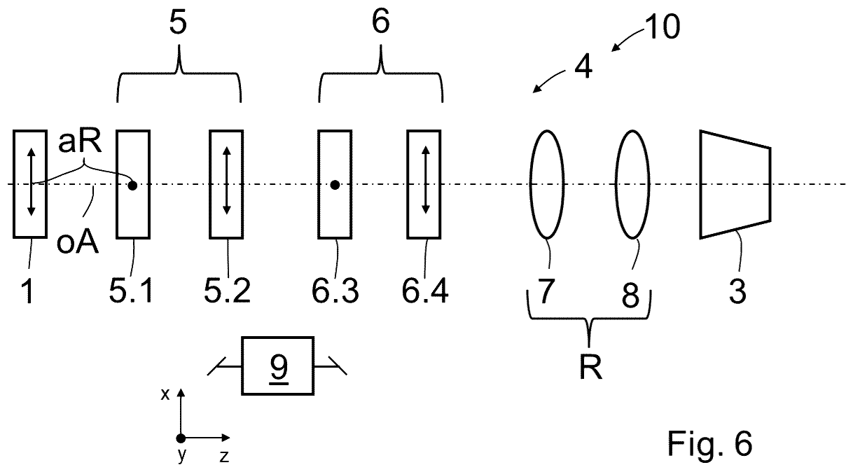

The reference signs already introduced in regard to FIGS. 1 to 5 are also still applicable and designate identical technical elements in all the drawings.

A first embodiment of an illumination device 4 according to the invention is shown by way of example as a constituent part of a microscope 10, in particular of a light sheet microscope 10, in FIG. 6 and comprises as essential constituent parts a first lens group 5 having a first optical element 5.1 and a second optical element 5.2, a second lens group 6 having a third optical element 6.3 and a fourth optical element 6.4, a first optical lens 7 and a second optical lens 8. These components are arranged along an optical axis oA of an illumination beam path. If the illumination device 4 is a constituent part of a microscope 10, optionally a light source and further components such as for example optical units and light guides (none of which is shown) are disposed upstream of the optical elements 5.1 to 6.4, or a cylindrical lens 1 optionally disposed upstream thereof. In FIG. 6, an illumination objective 3 is present downstream of the second optical lens 8, the objective pupil (entrance pupil EP) of said illumination objective coinciding with a plane into which light beams 2 (see FIGS. 2 to 5) of the illumination radiation are focused.

The cylindrical lens 1 and the optical elements 5.1 to 6.4 are constructionally designed or configured such that these each have exactly one active direction aR (see also FIGS. 1 to 5). Along the arrangement of the elements 5.1 to 6.4, the orientation thereof is such that the respective active direction aR is rotated by 90° relative to the orientation of the directly preceding cylindrical lens 1 or of the directly preceding optical element 5.1 to 6.3. In this case, the active direction aR always points perpendicularly to the optical axis oA. Incoming light beams 2 of the illumination radiation are shaped perpendicularly to the active direction aR. For each of the elements 1 to 6.4, the active direction aR is illustrated by arrows by way of example if it points in the x-direction, while active directions aR in the y-direction are identified by a dot. The effects of the active directions aR are manifested in a first direction or respectively in a second direction, which are different from one another and perpendicular to the respective active direction aR. The courses of the first and second directions relative to the area of the drawing (x-z-plane) have been chosen to be parallel and respectively perpendicular to the area of the drawing merely by way of example and for the purpose of better representability.

In the example shown, the active direction aR of the cylindrical lens 1 points in the x-direction. The illumination radiation is therefore focused or shaped into the y-z-plane.

In the exemplary embodiment, the first to fourth optical elements 5.1 to 6.4 are controlledly settable. That means that their optical properties, in particular the manner and direction of the shaping of the illumination radiation, can be individually altered and set within the adjustment ranges of the respective optical elements 5.1 to 6.4. The control commands required for this purpose are generated and communicated by a controller 9, which is connected to the optical elements 5.1 to 6.4 in a manner suitable for communication of data. The controller 9 (for example a computer, a microcontroller, an FPGA) is advantageously configured such that it keeps available a current setting of the optical elements 5.1 to 6.4 and generates and communicates the required control commands according to a desired optical effect proceeding from the current settings.

A setting of the optical elements 5.1 to 6.4 can be effected on the basis of an already prescribed mode in which the individual settings are already defined. It is also possible for the individual settings to be prescribed by a user, for example by means of an input device such as a keyboard, a touchpad or voice control (not shown). What is likewise possible, by itself or in combination with the abovementioned options, is feedback control in which for example the properties of a generated light sheet and/or of captured image data are evaluated and lead to corresponding control commands as necessary.

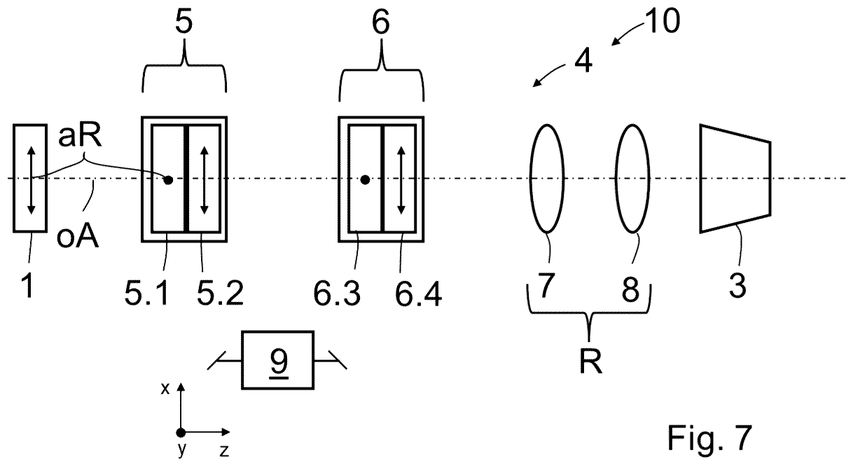

In a second exemplary embodiment of the invention, the optical elements 5.1 and 5.2 of the first group 5 and the optical elements 6.3 and 6.4 of the second group 6 are realized respectively by a spatial light modulator (SLM, represented with a boundary enclosing the corresponding optical elements 5.1, 5.2 and 6.3, 6.4, respectively) (FIG. 7). Both SLMs are controlled by means of the controller 9 such that the illumination radiation is influenced in the mutually orthogonal active directions in the sense mentioned above. The controller 9 is configured for this purpose such that control commands can be generated and communicated to the SLMs of the groups 5 and 6 by means of said controller.

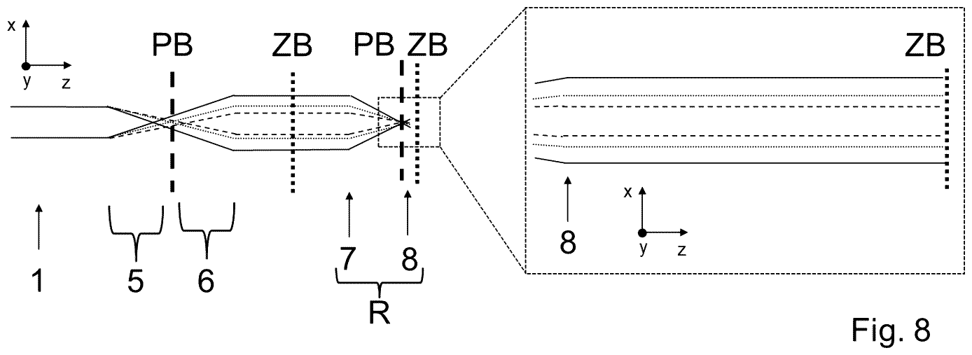

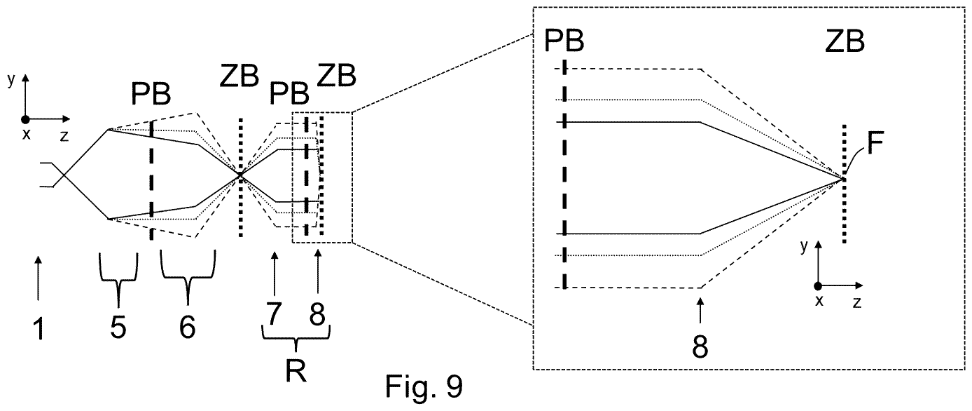

The functional principle of the invention will be explained with reference to FIGS. 8 and 9 on the basis of beam paths-shown in a simplified fashion—of one exemplary embodiment of an illumination device 4 according to the invention. Beam paths of the illumination radiation in the x-z-plane and also the positions of the cylindrical lens 1, of the two lens groups 5 and 6 and also of the two optical lenses 7 and 8 are indicated by way of example in FIG. 8. Pupil planes PB and intermediate image planes ZB that occur in the beam path are symbolized by differently dotted lines. The respective beam paths proceeding from the second optical lens 8 are shown on the right in the extracted partial figure illustrated in an enlarged manner.

Exemplary focal lengths of the cylindrical lens 1 and also of the optical elements 5.1 to 6.4 in the respective planes are indicated for three exemplary beam pairs in table 1. The cylindrical lens 1 focuses into the y-z-plane.

TABLE 1
Focal lengths and planes of the focusing
relative to a view of the x-z-plane.

| Light | Cylindrical | x-z-plane | y-z-plane | x-z-plane | y-z-plane |
|---|---|---|---|---|---|
| beam 2 | lens 1 | 5.1 | 5.2 | 6.3 | 6.4 |
| — | f = ∞ | 150 | f = ∞ | 250 | f = ∞ |
| — | f = ∞ | 200 | f = ∞ | 200 | f = ∞ |
| — | f = ∞ | 250 | f = ∞ | 150 | f = ∞ |

What is of importance for the invention is that in the x-z-plane the light beams 2 downstream of the lens group 6 are collimated in the intermediate image ZB. The light beams 2 are focused at a stationary point in the following pupil plane PB. Different numerical apertures that are essential for a resulting width B of a light sheet can be set by the effect of the first lens group 5. The second lens group 6 serves to collimate the light beams downstream of this group and to form the focus point in a stationary manner downstream of the optical lens 7 in the pupil plane PB.

FIG. 9 represents the paths of the pairs of light beams 2 in the y-z-plane, these pairs being shown by way of example and illustrated using different types of dashes. The associated focal lengths and respective planes are indicated in table 2. In the intermediate image plane ZB downstream of the second lens group 6, the light beams 2 are directed into a stationary focus. The light beams 2 accordingly proceed parallel to one another in the pupil plane PB downstream of the first optical lens 7. Downstream of the second optical lens 8, the light beams 2 pass into a common focus F in the intermediate image plane ZB there, without the occurrence of axial aberrations as in the prior art. Therefore, the numerical apertures subject to which the light beams 2 pass into the downstream intermediate image plane ZB can be altered and set in a targeted manner by corresponding control of the first and second lens groups 5 and 6.

The first lens group 5, depending on its control, causes a convergence or divergence of the illumination radiation beam. The effect of the second lens group 6 causes that to become a respective desired numerical aperture of the light beams 2 in the intermediate image plane ZB. The second lens group 6 additionally serves for keeping stationary the focus (see enlarged partial illustration) in the intermediate image plane ZB.

As a result of the possibilities according to the invention for manipulation in the various planes, a thickness D and usable length RL of a generated light sheet can be set in this way.

TABLE 2
Focal lengths and planes of the focusing
relative to a view of the y-z-plane.

| Light | Cylindrical | x-z-plane | y-z-plane | x-z-plane | y-z-plane |
|---|---|---|---|---|---|
| beam 2 | lens 1 | 5.1 | 5.2 | 6.3 | 6.4 |
| — | f = 50 | f = ∞ | 175 | f = ∞ | 250 |
| — | f = 50 | f = ∞ | 200 | f = ∞ | 200 |
| — | f = 50 | f = ∞ | 250 | f = ∞ | 175 |

### LIST OF REFERENCE SIGNS

1 cylindrical lens
2 light beams
3 illumination objective
4 illumination device
5 first lens group
5.1 first optical element
5.2 second optical element
6 second lens group
6.3 third optical element
6.4 fourth optical element
7 first optical lens
8 second optical lens
9 controller
10 microscope
aR active direction
B width
D thickness
EP entrance pupil, objective pupil
F focus
0A optical axis
PB pupil plane
pR passive direction
R relay optical unit
RL Rayleigh length, usable length
ZB intermediate image plane

1. An illumination device having an illumination beam path that includes first, second, third, and fourth optical elements for shaping an illumination radiation in each case in a direction orthogonal to an optical axis, wherein:
each of the optical elements, in exactly one direction, either
has an optically refractive effect and as a result the illumination radiation is shaped in a direction transversely to the active direction or
influences a wavefront of the illumination radiation and as a result the illumination radiation is shaped in a direction transversely to an active direction of the optical element,
wherein the active directions of successive optical elements of the first, second, third, and fourth optical elements are directed orthogonally to one another, and
wherein the illumination radiation downstream of the fourth optical element is directed or can be directed into a common focus by means of at least one relay optical unit comprising at least one optical lens in each case.

2. The illumination device according to claim 1, wherein the relay optical unit is formed by at least a first optical lens and a second optical lens each having a fixed focal length.

3. The illumination device according to claim 1, wherein a cylindrical lens is disposed upstream of the first to fourth optical elements, wherein the cylindrical lens has an optically refractive effect in exactly one direction and as a result the illumination radiation is shaped in a direction transversely to the active direction and the active directions of the cylindrical lens and of the successive optical elements are each directed orthogonally to one another.

4. The illumination device according to claim 1, wherein at least one of the first to fourth optical elements is exchangeable, wherein individual configurations of the optical elements are coordinated with one another in order to generate a focus which has desired dimensions laterally with respect to the optical axis.

5. The illumination device according to claim 1, wherein the each of the first, second, third, and fourth optical elements includes a controllably-settable optical element.

6. The illumination device according to claim 5, wherein the first to fourth optical elements include a controllable liquid lens.

7. The illumination device according to claim 5, wherein the first to fourth optical elements include a spatial light modulator.

8. The illumination device according to claim 1, wherein the first and second optical elements are combined in a first group and the third and fourth optical elements are combined in a second group and for each group are realized by a spatial light modulator, and the device further comprising a controller that is configured to control the light modulator of each group such that the illumination radiation is shaped in two mutually orthogonal active directions.

9. The illumination device according to claim 1, wherein the focus of the relay optical unit is directed into an entrance pupil of an illumination objective.

10. A method for setting a shape of an illumination radiation in two directions independently of one another, in which method an illumination radiation is shaped by means of a number of optically effective components in each case in exactly one direction orthogonal to an optical axis of an illumination beam path,
wherein an illumination radiation guided along the illumination beam path is shaped successively by the effect of optical components in first and second directions orthogonal to the optical axis, wherein the first and second directions are each directed orthogonally to one another, by a procedure in which
an illumination radiation is shaped successively by means of a first optical element, a second optical element, a third optical element and a fourth optical element alternately in one of the first and second directions, respectively, and
the shaped illumination radiation downstream of the fourth optical element is directed into a common focus by means of at least one relay optical unit comprising at least one optical lens in each case.

11. The method according to claim 10 for generating a light sheet,
wherein an illumination radiation guided along the illumination beam path is shaped successively by the effect of an optical component, in particular of a cylindrical lens, in a first direction, which is orthogonal to the optical axis,
the shaped illumination radiation is shaped in a second direction, which is orthogonal to the first direction, by means of a first optical element,
the shaped illumination radiation is shaped in the first direction by means of a second optical element,
the shaped illumination radiation is shaped in the second direction by means of a third optical element,
the shaped illumination radiation is shaped in the first direction by means of a fourth optical element, and
the shaped illumination radiation downstream of the fourth optical element is directed onto at least one relay optical unit comprising at least one optical lens in each case, and
the illumination radiation is directed into a common focus by the effect of the relay optical unit.

12. The method according to claim 10, wherein the focus is set by means of a controlled influencing of the optical effects of at least one of the optical elements with regard to desired dimensions laterally with respect to the optical axis of the illumination beam path, wherein two lateral dimensions directed orthogonally to one another are set independently of one another.

13. The method according to claim 11, wherein the focus is directed into an entrance pupil of an illumination objective in order to generate a light sheet having a predetermined thickness and waist length in a sample space.

14. The method according to claim 10, wherein the focus is positioned in the direction of the optical axis by virtue of at least one of the optical elements being controllably settable and the focus is positioned by virtue of the at least one optical element being controlled, in particular by control commands of a controller, and the optical effect of said at least one optical element being altered.
